(19) United States
(12) Patent Application Publication
(10) Pub. No.: US 2012/0126181 A1
(43) Pub. Date: May 24, 2012

(54) NANOWIRE PREPARATION METHODS, COMPOSITIONS, AND ARTICLES

(76) Inventors: David R. Whitcomb, Woodbury, MN (US); William D. Ramsden, Afton, MN (US); Doreen C. Lynch, Afton, MN (US)

(21) Appl. No.: 13/110,977

(22) Filed: May 19, 2011

Related U.S. Application Data
(60) Provisional application No. 61/415,952, filed on Nov. 22, 2010.
(60) Provisional application No. 61/429,595, filed on Jan. 4, 2011.

(51) Int. Cl. H01B 1/02; C22B 5/00; B82Y 99/00

(52) U.S. Cl. 252/503; 75/392; 420/501; 252/514; 977/762

(57) ABSTRACT

Preparation methods, compositions, and articles useful for electronic and optical applications. Methods for reducing metal ions to metals in the presence of IUPAC Group 14 elements in their +2 oxidation state, the metal products, and articles comprising the metal products. Compositions comprising metal nanowires and ions of IUPAC Group 14 elements, the metal nanowires, and articles comprising the metal nanowires.

### CROSS REFERENCE TO RELATED APPLICATIONS

Priority is claimed from U.S. Provisional Application No. 61/415,952, filed Nov. 22, 2010, entitled METAL ION CATALYSIS OF AgNW FORMATION, hereby incorporated by reference in its entirety.

Priority is claimed from U.S. Provisional Application No. 61/429,595, filed Jan. 4, 2011, entitled METAL ION CATALYSIS OF METAL ION REDUCTION, METHODS, COMPOSITIONS, AND ARTICLES, hereby incorporated by reference in its entirety.

### BACKGROUND

The general preparation of silver nanowires (10-200 aspect ratio) is known. See, for example, Angew. Chem. Int. Ed. 2009, 48, 60, Y. Xia, Y. Xiang, B. Lim, S. E. Skrabalak, which is hereby incorporated by reference in its entirety. Such preparations typically employ Fe²⁺ or Cu²⁺ ions to “catalyze” the wire formation over other morphologies. The controlled preparation of silver nanowires having the desired lengths and widths, however, is not known. For example, the Fe²⁺ produces a wide variety of lengths or thicknesses and the Cu²⁺ produces wires that are too thick for many applications.

When iron or copper are used, they are typically provided as the metal halide salts FeCl₂ or CuCl₂. Other metal halide salts have been used in nanowire synthesis. See, for example, J. Jiu, K. Murai, D. Kim, K. Kim, K. Suganuma, Mat. Chem. & Phys., 2009, 114, 333, which refers to NaCl, CoCl₂, CuCl₂, NiCl₂ and ZnCl₂, and S. Nandikonda, “Microwave Assisted Synthesis of Silver Nanorods,” M. S. Thesis, Auburn University, Auburn, Ala., USA, Aug. 9, 2010, which refers to NaCl, KCl, MgCl₂, CaCl₂, MnCl₂, CuCl₂, and FeCl₃. Japanese patent application publication 2009-155674 discloses SnCl₄ as a chloride source.

### SUMMARY

At least some embodiments provide methods comprising providing at least one first composition comprising at least one first reducible metal ion, and reducing the at least one first reducible metal ion to at least one first metal in the presence of at least one second metal ion comprising at least one IUPAC Group 14 element in its +2 oxidation state.

In such methods, the at least one first reducible metal ion may, for example, comprise at least one coinage metal ion, or at least one ion of an IUPAC Group 11 element, such as, for example, at least one silver ion. In at least some embodiments, the at least one first composition comprises silver nitrate.

In such methods, the at least one second metal ion may, for example, comprise tin in its +2 oxidation state, or it may, for example, comprise germanium in its +2 oxidation state, or it may, for example, comprise both tin in its +2 oxidation state and germanium in its +2 oxidation state.

In such methods, the reduction of the first reducible metal ion may, in some cases, occur in the presence some or all of at least one halide ion, at least one protecting agent, or at least one polyol.

Some embodiments provide products comprising the at least one first metal produced by such methods. In some cases, such products may comprise at least one metal nanowire.

Other embodiments provide articles comprising such products.

Still other embodiments provide compositions comprising at least one metal nanowire and at least one ion of an IUPAC Group 14 element. In some cases, the at least one metal nanowire comprises at least one silver nanowire. Such a metal nanowire may, for example, comprise a smallest dimension between about 10 nm and about 300 nm. Or such a metal nanowire may, for example, comprise an aspect ratio between about 50 and about 10,000.

Yet still other embodiments provide products comprising such metal nanowires or articles comprising such products. Non-limiting examples of such articles include electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

These embodiments and other variations and modifications may be better understood from the brief description of the drawings, detailed description, examples, additional embodiments, figures, and claims that follow. Any embodiments provided are given only by way of illustrative example. Other desirable objectives and advantages inherently achieved may occur or become apparent to those skilled in the art. The invention is defined by the appended claims.

### BRIEF DESCRIPTION OF THE DRAWINGS

FIG. 1 shows a micrograph of the purified product of Comparative Example 1.

FIG. 2 shows an optical micrograph of the product of Comparative Example 2.

FIG. 3 shows an optical micrograph of the product of Comparative Example 3.

FIG. 4 show s an optical micrograph of the product of Example 4 synthesized in the presence of SnCl₂.

FIG. 5 shows a scanning electron micrograph of the purified product of Example 4.

FIG. 6 shows an optical micrograph of the product of Example 5.

FIG. 7 shows a scanning electron micrograph of the purified product of Example 5.

FIG. 8 shows an optical micrograph of the product of Example 11.

FIG. 9 shows an optical micrograph of the product of Example 12 synthesized in the presence of 26 μM SnCl₂.

FIG. 10 shows an optical micrograph of the product of Example 12 synthesized in the presence of 48 μM SnCl₂.

FIG. 11 shows an optical micrograph of the product of Example 12 synthesized in the presence of 90 μM SnCl₂.

FIG. 12 shows an optical micrograph of the product of Comparative Example 13.

### DETAILED DESCRIPTION

U.S. Provisional Application No. 61/415,952, filed Nov. 22, 2010, and U.S. Provisional Application No. 61/429,595, filed Jan. 4, 2011, are both hereby incorporated by reference in their entirety.

### Reducible Metal Ions and Metal Products

Some embodiments provide methods comprising reducing at least one reducible metal ion to at least one metal. A reducible metal ion is a cation that is capable of being reduced to a metal under some set of reaction conditions. In such methods, the at least one first reducible metal ion may, for example, comprise at least one coinage metal ion. A coinage metal ion is an ion of one of the coinage metals, which include copper, silver, and gold. Or such a reducible metal ion may, for example, comprise at least one ion of an IUPAC Group 11 element. IUPAC Group 11 elements are sometimes referred to as Group IB elements, based on historic nomenclature. An exemplary reducible metal ion is a silver cation. Such reducible metal ions may, in some cases, be provided as salts. For example, silver cations might, for example, be provided as silver nitrate.

In such embodiments, the at least one metal is that metal to which the at least one reducible metal ion is capable of being reduced. For example, silver would be the metal to which a silver cation would be capable of being reduced.

### Nanostructures, Nanostructures, and Nanowires

In some embodiments, the metal product formed by such methods is a nanostructure, such as, for example, a one-dimensional nanostructure. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, and the like. “One-dimensional” nanostructures have one dimension that is much larger than the other two dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

Such methods may be used to prepare nanostructures other than nanowires, such as, for example, nanocubes, nanorods, nanopyramids, nanotubes, and the like. Nanowires and other nanostructure products may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

Preparation Methods

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire. Such a reduction may be carried out in a reaction mixture that may, for example, comprise one or more polyols, such as, for example, ethylene glycol (EG), propylene glycol, butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 120° C. to about 190° C.

### IUPAC Group 14 Metal Ions

In some embodiments, the reduction of the reducible metal ion occurs in the presence of at least one second metal ion comprising at least one IUPAC Group 14 element in its +2 oxidation state. IUPAC Group 14 elements are also sometimes referred to as Group IV elements, based on historic nomenclature.

Not all oxidation states are catalytically active. Applicants have determined that the Group 14 element tin in its +4 oxidation state does not appear to be effective for silver nanowire synthesis, as shown in Comparative Examples 2 and 3. By contrast, Applicants have discovered that Group 14 elements in their +2 oxidation state, such as, for example, tin as Sn²⁺ and germanium as Ge²⁺, can be used to prepare silver nanowires, with desirable control of thickness, or length, or both, relative to conventional preparation using Fe²⁺ or Cu²⁺, and often with minimal nanoparticle contamination.

### Additional Embodiments

U.S. Provisional Application No. 61/415,952, filed Nov. 22, 2010, and U.S. Provisional Application No. 61/429,595, filed Jan. 4, 2011, discloses the following exemplary non-limiting embodiments.

In embodiment 1, there is described a method comprising: (a) providing a composition comprising: at least one compound comprising Ag(I), at least one salt of at least one Group IV element, at least one protecting agent, and at least one solvent; and (b) reducing the Ag(I) to silver metal.

Further to the method of embodiment 1, the at least one compound comprises silver nitrate.

Further to the method of embodiment 1, the at least one salt comprises the at least one Group IV element in its +2 valence state.

Further to the method of embodiment 1, the at least one salt comprises at least one chloride.

Further to the method of embodiment 1, the at least one salt comprises stannous chloride or a hydrate of stannous chloride.

Further to the method of embodiment 1, the at least one Group 1V element comprises tin.

Further to the method of embodiment 1, the at least one protecting agent comprises at least one of: one or more surfactants, one or more acids, or one or more polar polymers.

Further to the method of embodiment 1, the at least one protecting agent comprises polyvinylpyrrolidinone.

Further to the method of embodiment 1, the at least one solvent comprises at least one polyol.

Further to the method of embodiment 1, the at least one solvent comprises at least one of: ethylene glycol, propylene glycol, glycerol, one or more sugars, or one or more carbohydrates.

Further to the method of embodiment 1, the composition has a molar ratio of the at least one Group IV element to Ag(I) from about 0.0001 to about 0.1.

Further to the method of embodiment 1, the reduction is carried out at one or more temperatures from about 120° C. to about 190° C.

Further to the method of embodiment 1, the method further comprises inerting one or more of the composition, the at least one compound comprising Ag(I), the at least one salt of the at least one Group IV element, the at least one protecting agent, or the at least one solvent.

There is described a silver metal produced according to the method of embodiment 1.

In embodiment 2, there is described at least one article comprising the silver metal produced according to the method of embodiment 1.

Further to the at least one article of embodiment 2, the silver metal comprises at least one silver nanowire.

Further to the at least one article of embodiment 2, the at least one silver nanowire has an average diameter of between about 20 nm and about 150 nm.

Further to the at least one article of embodiment 2, the at least one silver nanowire has an aspect ratio from about 50 to about 10,000.

In embodiment 3, there is described at least one silver nanowire with an average diameter of between 20 nm and about 150 nm, and with an aspect ratio from about 50 to about 10,000.

In embodiment 4, there is described at least one article comprising the at least one silver nanowire of embodiment 3.

In embodiment 5, there is described a method comprising: (a) providing a composition comprising: (i) at least one first compound comprising at least one first reducible metal ion, (ii) at least one second compound comprising at least one second metal or metal ion differing in atomic number from said at least one first reducible metal, said at least one second metal or metal ion comprising at least one non-transition element, and (iii) at least one solvent; and (b) reducing the at least one first reducible metal ion to at least one first metal.

Further to the method of embodiment 5, the composition further comprises at least one protecting agent.

Further to the method of embodiment 5, the at least one protecting agent comprises at least one of: one or more surfactants, one or more acids, or one or more polar polymers.

Further to the method of embodiment 5, the at least one protecting agent comprises polyvinylpyrrolidinone.

Further to the method of embodiment 5, the method further comprises inerting the at least one protecting agent.

Further to the method of embodiment 5, the at least one first reducible metal ion comprises at least one coinage metal ion.

Further to the method of embodiment 5, the at least one first reducible metal ion comprises at least one ion of an element from IUPAC Group 11.

Further to the method of embodiment 5, the at least one first reducible metal ion comprises at least one ion of silver.

Further to the method of embodiment 5, the at least one first compound comprises silver nitrate.

Further to the method of embodiment 5, the at least one second metal or metal ion comprises at least one IUPAC Group 14 element.

Further to the method of embodiment 5, the at least one second metal or metal ion comprises germanium or an ion of germanium.

Further to the method of embodiment 5, wherein the at least one second compound comprises at least one salt of said at least one second metal or metal ion.

Further to the method of embodiment 5, the at least one salt comprises at least one chloride.

Further to the method of embodiment 5, the at least one solvent comprises at least one polyol.

Further to the method of embodiment 5, the at least one solvent comprises at least one of: ethylene glycol, propylene glycol, glycerol, one or more sugars, or one or more carbohydrates.

Further to the method of embodiment 5, the composition has a ratio of the total moles of the at least one second metal or metal to the moles of the at least one first reducible metal ion from about 0.0001 to about 0.1.

Further to the method of embodiment 5, the reduction is carried out at one or more temperatures from about 120° C. to about 190° C.

Further to the method of embodiment 5, the method further comprises inerting one or more of: the composition, the at least one compound comprising at least one first reducible metal ion, the at least one second metal or metal ion, or the at least one solvent.

In embodiment 6, there is described at least one first metal produced according to the method of embodiment 5.

In embodiment 7, there is described at least one article comprising the at least one first metal produced according to the method of embodiment 5.

Further to the at least one article of embodiment 7, the at least one first metal comprises one or more nanowires, nanocubes, nanorods, nanopyramids, or nanotubes.

Further to the at least one article of embodiment 7, the at least one first metal comprises at least one object having an average diameter of between about 10 nm and about 500 nm.

Further to the at least one article of embodiment 7, the at least one first metal comprises at least one object having an aspect ratio from about 50 to about 10,000.

In embodiment 8, there is described at least one metal nanowire with an average diameter of between about 10 nm and about 150 nm, and with an aspect ratio from about 50 to about 10,000.

Further to the nanowire of embodiment 8, the at least one metal comprises at least one coinage metal.

Further to the nanowire of embodiment 8, the at least one metal comprises at least one element of IUPAC Group 11.

Further to the nanowire of embodiment 8, the at least one metal comprises silver.

In embodiment 9, there is described least one article comprising the at least one metal nanowire of embodiment 8.

### EXAMPLES

### Example 1 (Comparative)

To a 500 mL reaction flask containing 200 mL ethylene glycol (EG), 1.92 mL of a 4 mM CuCl₂ solution in EG was added and degassed by bubbling nitrogen into the solution using a glass pipette. Stock solutions of 0.094 M AgNO₃ in EG and 0.282 M polyvinylpyrrolidinone (PVP) in EG were also degassed by bubbling nitrogen into the solutions. Two syringes were then loaded with 20 mL each of the AgNO₃ and PVP solutions. The reaction mixture was heated to 145° C. under nitrogen and, after the reaction mixture was held 60 minutes at the set point temperature, the AgNO₃ and PVP solutions were then added at a constant rate over 25 minutes via a 20 gauge TEFLON® fluoropolymer syringe needle. The reaction mixture was held at 145° C. for 90 minutes and then allowed to cool to ambient temperature.

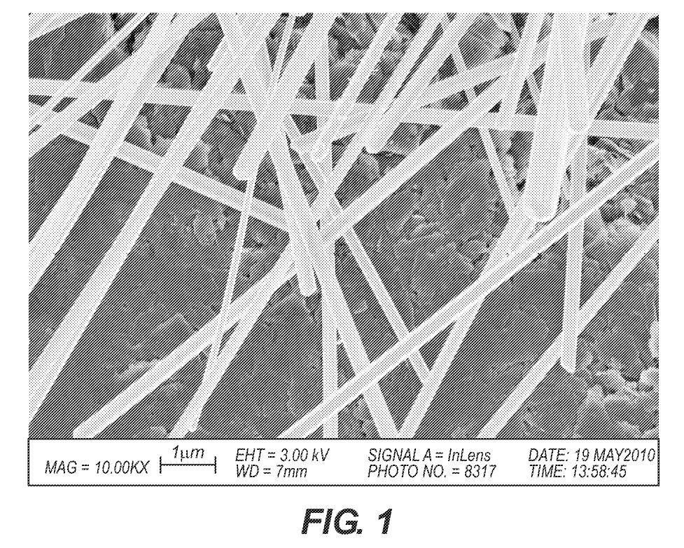

From the cooled mixture, a 15 mL aliquot was diluted with 35 mL isopropanol (IPA), centrifuged for 15 minutes at 1500 rpm, decanted, and re-dispersed in 5 mL IPA. This sample was used for analysis by scanning electron microscopy (SEM). FIG. 1 is a scanning electron micrograph of the nanowire product, which had an average diameter of 254 nm.

### Example 2 (Comparative)

To a 500 mL reaction flask containing 280 mL EG, 1.6 g of a freshly prepared 11.5 mM SnCl₄.5H₂O solution in EG was added and degassed for 2 hrs by bubbling nitrogen into the solution using a glass pipette with mechanical stirring at 100 rpm. Stock solutions of 0.25 M AgNO₃ in EG and 0.77 M PVP in EG were also degassed by bubbling N₂ into the solutions for 60 mM. Two syringes were loaded with 20 mL each of the AgNO₃ and PVP solutions. The reaction mixture was heated to 145° C. under nitrogen and, after the reaction mixture was held 10 minutes at the set point temperature, AgNO₃ and PVP solutions were added at a constant rate over 25 minutes via a 12 gauge TEFLON® fluoropolymer syringe needle. The reaction mixture was held at 145 ° C. for 90 minutes, at which time a sample was taken for analysis by optical microscopy, and then allowed to cool to ambient temperature.

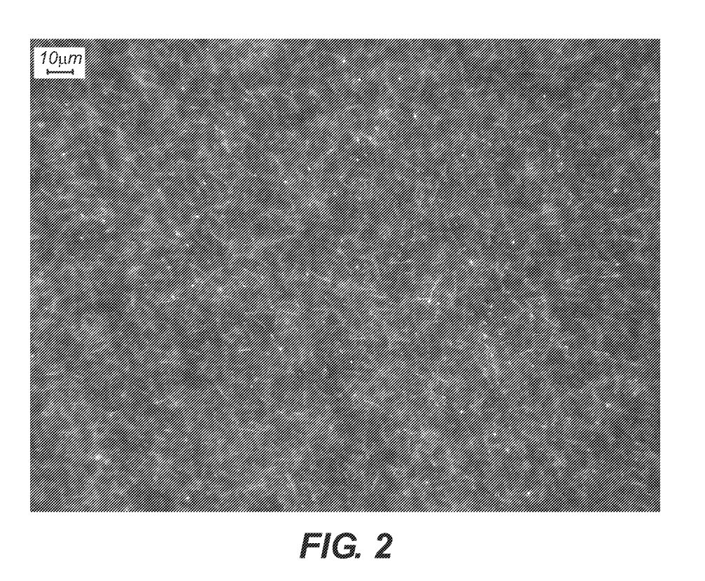

FIG. 2 is an optical micrograph of this product sample. Compared to Sn²⁺ under similar conditions, Sn⁴⁺ does not appear to function well in controlling silver morphology, based on its low yield of only short silver nanowires and its high yield of silver nanoparticles.

### Example 3 (Comparative)

To a 500 mL reaction flask containing 280 mL EG, 70 μL of a freshly prepared 0.14 M anhydrous SnCl₄ solution in EG was added and degassed for 2 hrs by bubbling nitrogen into the solution using a glass pipette with mechanical stirring at 100 rpm. Stock solutions of 0.25 M AgNO₃ in EG and 0.77 M PVP in EG were also degassed by bubbling N₂ into the solutions for 60 min. Two syringes were loaded with 20 mL each of the AgNO₃ and PVP solutions. The reaction mixture was heated to 145° C. under nitrogen and, after the reaction mixture was held 10 minutes at the set point temperature, AgNO₃ and PVP solutions were added at a constant rate over 25 minutes via a 12 gauge TEFLON® fluoropolymer syringe needle. The reaction mixture was held at 145° C. for 90 minutes, at which time a sample was taken for analysis by optical microscopy, and then allowed to cool to ambient temperature.

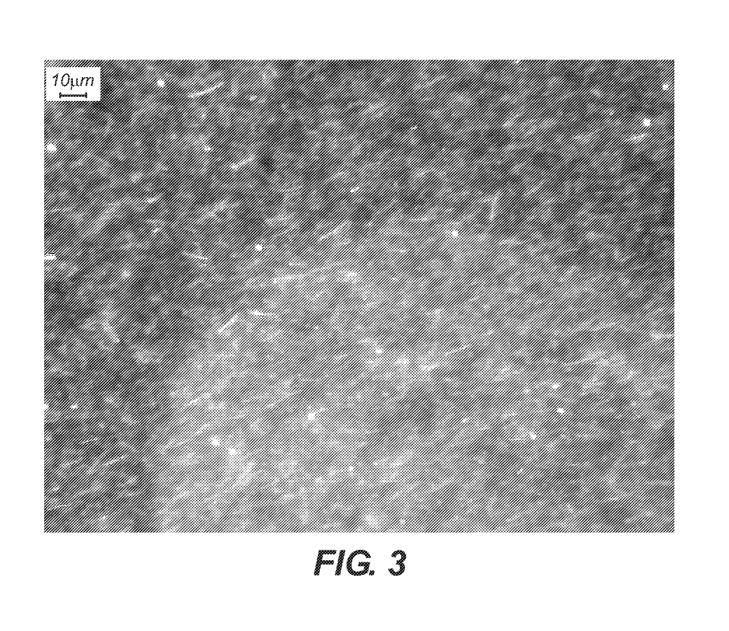

FIG. 3 is an optical micrograph of this product sample. Compared to Sn²⁺ under similar conditions, Sn⁴⁺ does not appear to function well in controlling silver morphology, based on its low yield of only short silver nanowires and its high yield of silver nanoparticles.

### Example 4

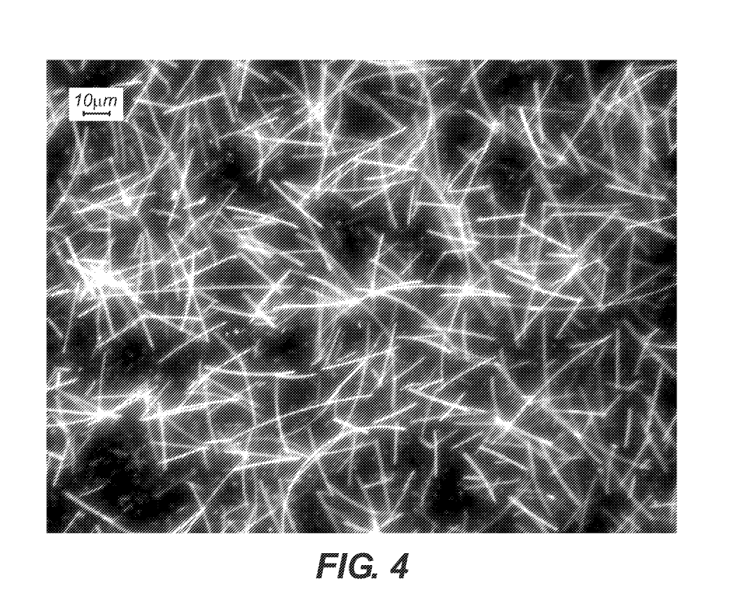

To a 500 mL reaction flask containing 280 mL EG, 1.0 mL of 9.3 mM SnCl₂ in EG was added and degassed for 2 hrs by bubbling nitrogen into the solution using a glass pipette with mechanical stirring at 100 rpm. Stock solutions of 0.25 M AgNO₃ in EG and 0.77 M PVP in EG were also degassed by bubbling N₂ into the solutions for 60 min. Two syringes were loaded with 20 mL each of the AgNO₃ and PVP solutions. The reaction mixture was heated to 145° C. under nitrogen and, after the reaction mixture was held 10 minutes at the set point temperature, AgNO₃ and PVP solutions were added at a constant rate over 25 minutes via a 12 gauge TEFLON® fluoropolymer syringe needle. The reaction mixture was held at 145° C. for 90 minutes, at which time a sample was taken for analysis by optical microscopy, and then allowed to cool to ambient temperature. FIG. 4 is an optical micrograph of this product sample.

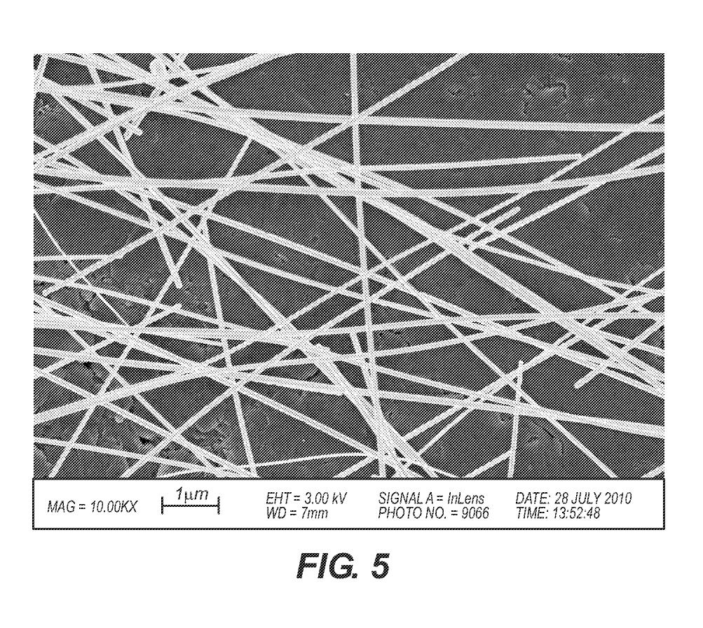

From the cooled mixture, a 15 mL aliquot was diluted with 35 mL IPA, centrifuged for 15 minutes at 1500 rpm, decanted, and re-dispersed in 5 mL IPA. This purified sample was used for analysis by SEM. FIG. 5 is a scanning electron micrograph of this purified product sample. The average nanowire diameter was 97±24 nm.

### Example 5

To a 500 mL reaction flask containing 280 mL EG. 2.0 g of 13.4 mM GeCl₂ was added and degassed for 2 hrs by bubbling N₂ into the solution using a glass pipette at room temperature with mechanical stirring at 100 rpm. Stock solutions of 0.25 M AgNO₃ in EG and 0.77 M PVP in EG were also degassed by bubbling N₂ into the solutions for 60 min. Two syringes were loaded with 20 mL each of the AgNO₃ and PVP solutions. The reaction mixture was heated to 145° C. under N₂ and then, after the reaction mixture was held for 10 min, the AgNO₃ and PVP solutions were added at a constant rate over 25 minutes via 12 gauge TEFLON® fluoropolymer syringe needles. The reaction mixture was held at 145° C. for 90 minutes, at which time a sample was taken for analysis by optical microscopy, and then allowed to cool to room temperature.

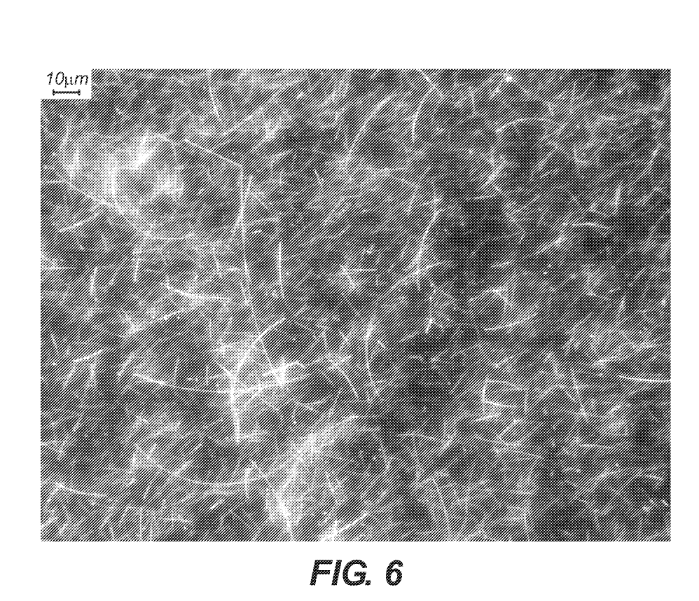

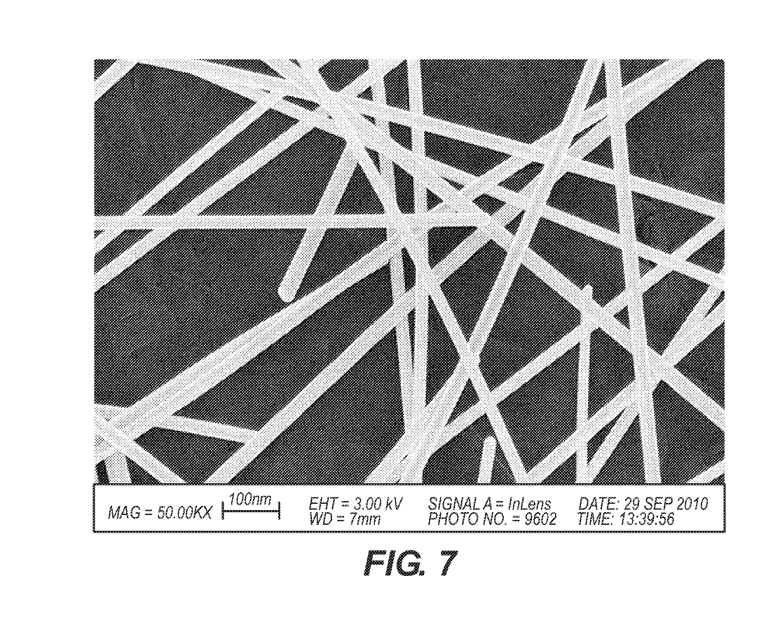

From the cooled mixture, a 15 mL aliquot was diluted with 35 mL IPA, centrifuged for 15 minutes at 1500 mm, decanted, and re-dispersed in 5 mL IPA. This purified sample was used for analysis by SEM. Optical and scanning electron micrographs, FIGS. 6 and 7, respectively, show the silver nanowires prepared using Ge²⁺, with minimal nanoparticle contamination. The average nanowire diameter was 31±16 nm and the average length was 8.7±2.7 μm.

### Example 6 (Comparative)

A suspension of colloidal silver(0) in EG was prepared according to the procedure of Silvert, P.-V.; Herrera-Urbina, R.; Duvauchelle, N.; Vijayakrishnan, V.; Elhsissen, K. T.; J. Mater. Chem. 1996, 6 (4), 573-577, which is hereby incorporated by reference in its entirety. Accordingly, to a solution of 1.5 g of 10,000 molecular weight PVP in 75 mL of EG was added 50.1 mg of silver nitrate. After stirring 12 minutes at 22° C., the solution was heated to 120° C. over 136 min, then held at 120° C. for 23 min to give the colloidal silver suspension.

A solution of 14.47 g of silver nitrate in 905 mL of EG and a solution of 83.76 g of 55,000 molecular weight PVP in 905 mL of EG were prepared and nitrogen bubbled into each for 3 hr. Into a 5 L round-bottomed flask equipped with a 4-bladed turbine stirrer was charged 3003 mL of EG and 19.2 mL of 0.006 M iron (II) chloride tetrahydrate in EG. Nitrogen was then bubbled through this mixture for 17 hr, which was then kept under a nitrogen blanket and heated to 146° C. 4.35 mL of the colloidal silver suspension was then added, followed by the silver nitrate and PVP solutions over 31 min. The resulting mixture was then held at 145-147° C. for 64 min, and then allowed to cool to room temperature.

The mixture was filtered through a screen to remove agglomerates and 826.5 g of the suspension was processed by adding an equal volume of acetone and centrifuging at 300 G for 45 min. The supernatant was decanted and discarded, while IPA was added to the residue and shaken for 30 min. This centrifugation/decanting/resuspension process was then repeated two times, after which evaporated drops of the nanowire suspension were examined by optical microscopy (for length) and by SEM (for diameter). More than 100 wires were measured by each method and the average length and standard deviation determined to be 13±16 μm and the average diameter and standard deviation to be 118±53 nm.

### Example 7

Stock solutions of 144.7 g of silver nitrate in 3000 mL of EG and 284.0 g of 55000 molecular weight PVP in 3000 mL of EG were prepared. The solutions were stored, maintaining a stream of bubbling nitrogen bubbling through each.

Into a 2 L cylindrical flask equipped with a 4-bladed turbine stirrer was charged 1684 mL of EG and 21.0 mg of tin (II) chloride dihydrate. Nitrogen was bubbled into through this mixture overnight. The mixture was then heated to 101° C., after which the nitrogen bubbling was stopped. The mixture was then further heated to and held at 144 to 146° C. Using a syringe pump, 120 mL of each stock solution of silver nitrate and PVP was added over 26 min, after which the mixture was held at temperature for an additional 60 min. The contents of the flask was drained into an ice-cooled beaker, filtered through a screen to remove agglomerates, and 811.26 g of the slurry processed by adding an equal volume of acetone and centrifuging at 400 G for 45 min. The supernatant was decanted and discarded, with the residue being resuspended in IPA by shaking for 11 min, followed again by centrifuging at 400 G for 45 min. After another cycle of shaking with IPA, centrifuging, and decanting the supernatant, IPA was added to the residue and a final silver nanowire suspension in IPA obtained. Evaporated drops of the nanowire suspension were examined by optical microscopy (for length) and SEM (for diameter). More than 100 wires were measured by each method and the average length and standard deviation determined to be 23±9 μm and the average diameter and standard deviation to be 80±18 nm.

### Example 8

Stock solutions of 144.7 g of silver nitrate in 3000 mL of EG and 284.0 g of 55000 molecular weight PVP in 3000 mL of EG were prepared. The solutions were stored, maintaining a stream of bubbling nitrogen bubbling through each.

Into a 10 L cylindrical flask equipped with a 4-bladed turbine stirrer was charged 7000 mL of ethylene glycol and 87.9 mg of tin (II) chloride dihydrate. Nitrogen was bubbled through this mixture overnight. The mixture was heated to 101° C., after which the nitrogen bubbling was stopped. The mixture was then further heated to and held at 144 to 146° C. Using a pump, 500 mL of each stock solution was added over 25 to 26 min, then the mixture held at temperature for an additional 1 hr. The contents of the flask was drained into an ice-cooled flask, filtered through a screen to remove agglomerates, and 775.62 g of the slurry was processed by adding an equal volume of acetone and centrifuging at 400 G for 45 min. The supernatant was decanted and discarded, the residue suspended in IPA by shaking for 24 min. The suspension was then centrifuged again at 400 G for 45 min. After another cycle of shaking with IPA, centrifuging, and decantation of the supernatant, IPA was then added to the residue and a final silver nanowire suspension in IPA obtained. Evaporated drops of the nanowire suspension were examined by optical microscopy (for length) and by SEM (for diameter). More than 100 wires were measured by each method and the average length and standard deviation were determined to be 24±9 μm and the average diameter and standard deviation to be 82±16 nm. There was only a low level of non-nanowire particles present.

### Example 9

The procedure of Example 8 was repeated with the following changes. 87.8 mg of tin (II) chloride dihydrate and 750 mL of each of the stock solutions were used, the PVP stock solution was added over 43 min, and the silver nitrate stock solution was added over 36 min. The product nanowire average length and standard deviation were determined to be 25±12 μm and the average diameter and standard deviation to be 92±25 nm. There was only a low level of non-nanowire particles present.

### Example 10

The procedure of Example 8 was repeated with the following changes. 175.8 mg of tin (II) chloride dihydrate was used, the silver nitrate stock solution consisted of 106.11 g of silver nitrate in 1100 mL of EG, the PVP stock solution consisted of 208.27 g of PVP in 1100 mL of EG, the stock solutions were added over 25 min, and the post-addition hold time was 33 min. The average length and standard deviation were determined to be 23±11 μm and the average diameter and standard deviation to be 80±22 nm. There was only a low level of non-nanowire particles present.

### Example 11

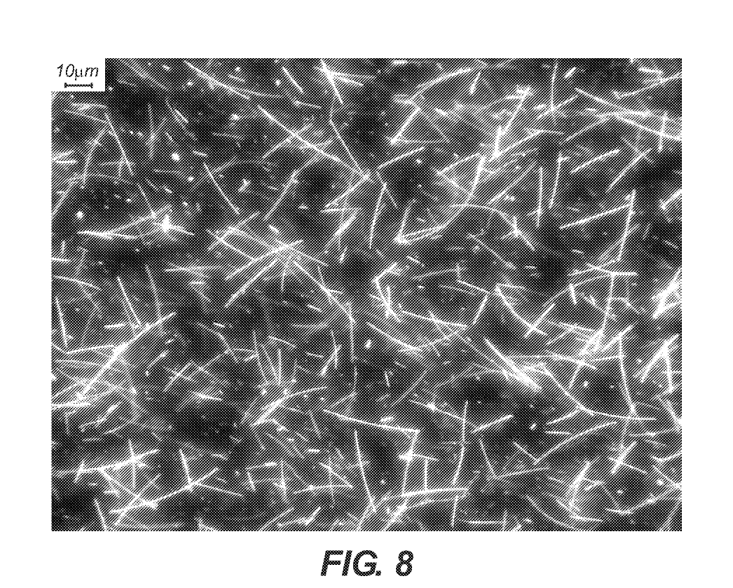

To a 500 mL reaction flask containing 280 mL EG, 1.1 g of 21 mM SnSO₄ in EG and 2.8 g of 13 mM NaCl in EG were added and degassed for 2 hrs by bubbling nitrogen into the solution using a TEFLON® fluoropolymer tube with mechanical stirring at 100 rpm. Stock solutions of 0.25 M AgNO₃ in EG and 0.84 M PVP in EG were also degassed by bubbling nitrogen into the solutions. Two syringes were loaded with 20 mL each of the AgNO₃ and PVP solutions. The nitrogen tube was retracted from the reaction mixture to blanket the headspace of the flask at approximately 0.5 L/min nitrogen. The reaction mixture was heated to 145° C. under nitrogen and then the AgNO₃ and PVP solutions were added at a constant rate over 25 minutes via a 12 gauge TEFLON® fluoropolymer syringe needle. The reaction mixture was held at 145° C. for 60 minutes, at which time a sample was taken for analysis by optical microscopy, and then allowed to cool to ambient temperature. FIG. 8 is an optical micrograph of this product sample. The average nanowire diameter was 81.7±27.9 nm and the average length was 17.2±10.0 μm.

### Example 12

To a 500 mL reaction flask containing 280 mL EG, sufficient SnCl₂.2H₂O in EG was added so as to provide a 26, 48, or 90 μM SnCl₂ solution as measured in the final reaction mixture. This mixture which was then degassed by sparging nitrogen into the solution overnight. Stock solutions of 0.282 M AgNO₃ in EG and 0.848 M PVP in EG were also degassed by sparging with nitrogen. Two syringes were loaded with 20 mL each of the AgNO₃ and PVP solutions. The reaction mixture was heated to 145° C. over 60 min. After 30 min of heating, nitrogen sparging was discontinued, and the reaction flask headspace was blanketed with nitrogen. After the reaction mixture temperature stabilized at the set point, mechanical agitation was started, and the AgNO₃ and PVP solutions were added at a constant rate over 25 minutes. This final reaction mixture was held at 145° C. for 60 minutes. After quenching in an ice bath, the product solution was filtered through a Buchner funnel to determine the level of agglomeration. The filtrate was then worked up by dilution with acetone, centrifugation at 400 G, and resuspension in 2-propanol.

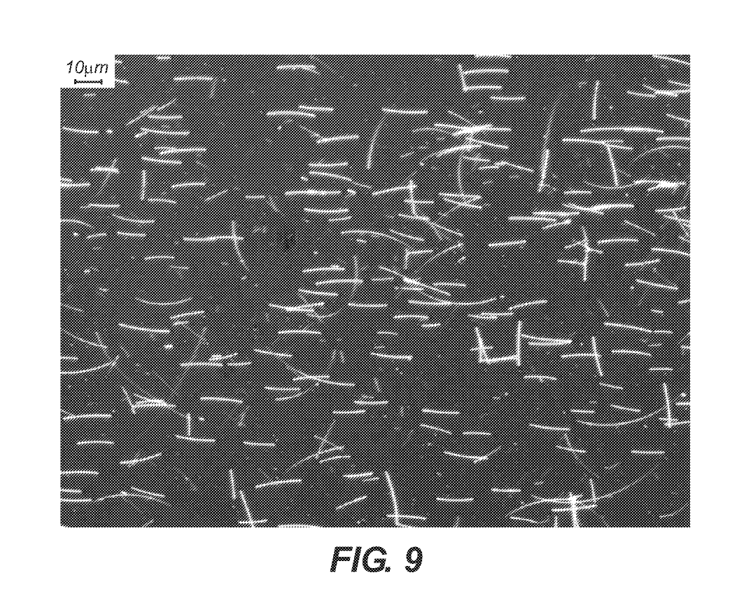

FIG. 9 is an optical micrograph of the product produced in the presence of the 26 μM SnCl₂ solution. No agglomerates were detected during filtration. The micrograph shows a high level of non-wire particles. The nanowires had an average diameter of 69±19 nm and an average length of 18.7±7.1 μm.

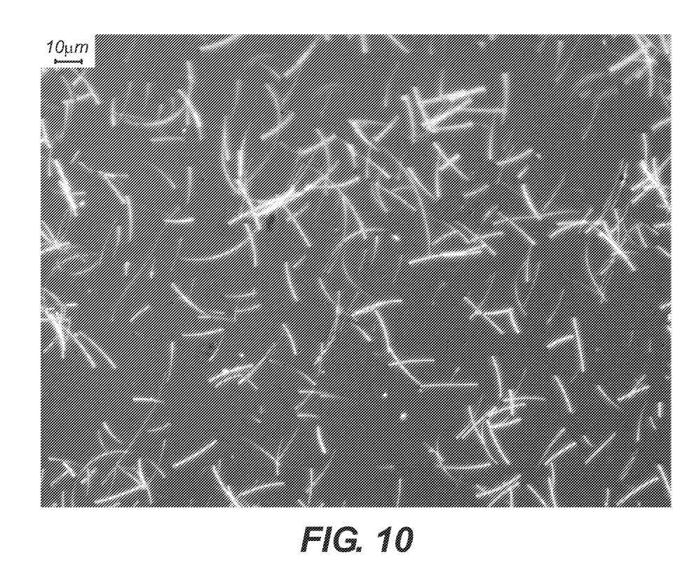

FIG. 10 is an optical micrograph of the product produced in the presence of the 48 μM SnCl₂ solution. No agglomerates were detected during filtration. The micrograph shows a low level of non-wire particles. The nanowires had an average diameter of 63+15 nm and an average length of 19.7±7.3 μm.

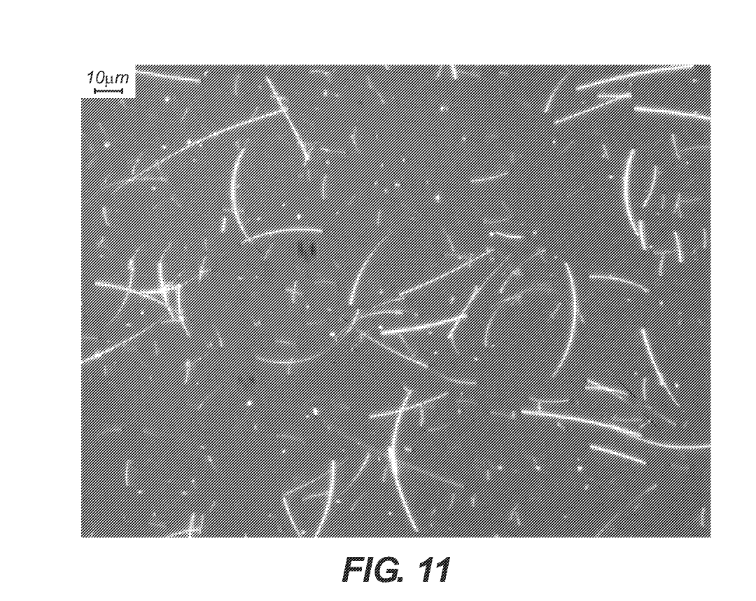

FIG. 11 is an optical micrograph of the product produced in the presence of the 90 μM SnCl₂ solution. No agglomerates were detected during filtration. The micrograph shows a high level of non-wire particles. The nanowires had an average diameter of 73+23 nm and an average length of 29.9±11.6 μm.

### Example 13 (Comparative)

The procedure of Example 12 was replicated, with the following changes: in place of the tin (II) chloride dihydrate solutions, 3 mL of 0.011 M sodium chloride in EG was used; the reaction time was extended by 30 minutes; and the centrifugation was performed at 600 G.

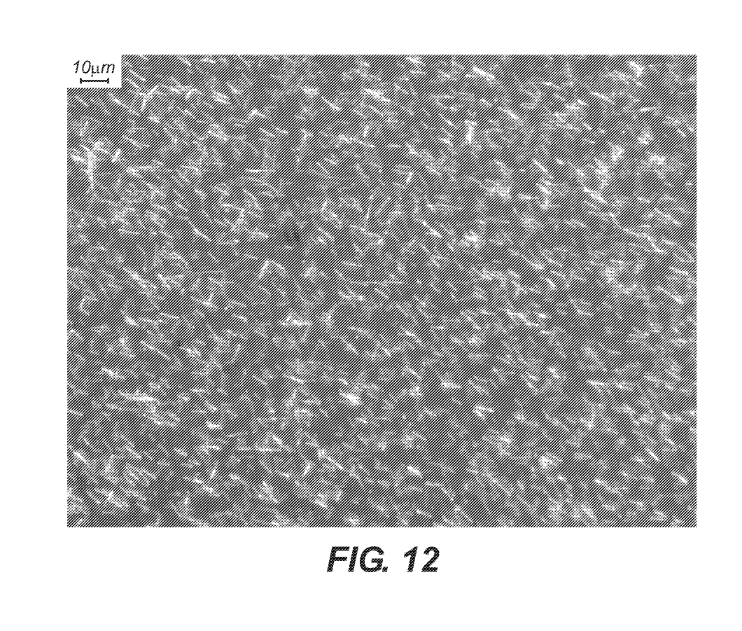

FIG. 12 is an optical micrograph of the product. The nanowires had an average diameter of 52±11 nm and an average length of 8.4±2.7 μm.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method comprising:
providing at least one first composition comprising at least one first reducible metal ion; and
reducing the at least one first reducible metal ion to at least one first metal in the presence of at least one second metal ion comprising at least one IUPAC Group 14 element in its +2 oxidation state.

2. The method according to claim 1, wherein the at least one first reducible metal ion comprises at least one coinage metal ion.

3. The method according to claim 1, wherein the at least one first reducible metal ion comprises at least one ion of an IUPAC Group 11 element.

4. The method according to claim 1, wherein the at least one first reducible metal ion comprises at least one silver ion.

5. The method according to claim 1, wherein the at least one composition comprises silver nitrate.

6. The method according to claim 1, wherein the at least one second metal ion comprises tin in its +2 oxidation state.

7. The method according to claim 1, wherein the at least one second metal ion comprises germanium in its +2 oxidation state.

8. The method according to claim 1, wherein the reduction occurs in the presence of at least one halide ion.

9. The method according to claim 1, wherein the reduction occurs in the presence of at least one protecting agent.

10. The method according to claim 1, wherein the reduction occurs in the presence of at least one polyol.

11. A product comprising the at least one first metal produced by the method according to claim 1.

12. The product according to claim 11, comprising at least one metal nanowire.

13. An article comprising the product according to claim 11.

14. A composition comprising at least one metal nanowire and at least one ion of an IUPAC Group 14 element.

15. The composition according to claim 14, wherein the at least one metal nanowire comprises at least one silver nanowire.

16. The composition according to claim 14, wherein the at least one metal nanowire comprises a smallest dimension between about 10 nm and about 300 nm.

17. The composition according to claim 14, wherein the at least one metal nanowire comprises an aspect ratio between about 50 and about 10,000.

18. A product comprising the at least one metal nanowire of the composition according to claim 14.

19. An article comprising the at least one product according to claim 18.

20. The article according to claim 19 comprising at least one of an electronic display, a touch screen, a portable telephone, a cellular telephone, a computer display, a laptop computer, a tablet computer, a point-of-purchase kiosk, a music player, a television, an electronic game, an electronic book reader, a transparent electrode, a solar cell, a light emitting diode, an electronic device, medical a medical imaging device, or a medical imaging medium.
